(19) United States
(12) Patent Application Publication
(10) Pub. No.: US 2017/0185187 A1
(43) Pub. Date: Jun. 29, 2017

(54) CONDUCTIVE FILM FOR TOUCH PANEL AND TOUCH PANEL

(71) Applicant: FUJIFILM Corporation, Tokyo (JP)

(72) Inventors: Masaya NAKAYAMA, Kanagawa (JP); Hiroshige NAKAMURA, Kanagawa (JP); Hiroyuki KOBAYASHI, Kanagawa (JP)

(73) Assignee: FUJIFILM Corporation, Tokyo (JP)

(21) Appl. No.: 15/418,844

(22) PCT Filed: May 18, 2015
(86) PCT No.: PCT/JP2015/064183

§ 371 Date: Jan. 30, 2017

(30) Foreign Application Priority Data
Sep. 8, 2014 (JP) 2014-182412

(51) Int. Cl. G06F 3/044

(52) U.S. Cl. CPC G06F 3/044; G06F 2203/04102; G06F 2203/04103; G06F 2203/04112

(57) ABSTRACT

Provided is a conductive film for a touch panel including: a flexible transparent resin substrate having a thickness equal to or smaller than 40 μm; a plurality of detection electrodes which are formed on at least one surface of the resin substrate; a plurality of peripheral wirings which are formed on at least one surface of the resin substrate and respectively connected to the plurality of detection electrodes; and a plurality of external connection terminals which are formed on at least one surface of the resin substrate and respectively connected to the plurality of peripheral wirings, in which the plurality of external connection terminals are arranged such that adjacent external connection terminals are separated from each other by a distance between terminals of 100 μm to 200 μm with a pitch equal to or smaller than 500 μm, and respectively have a terminal width equal to or greater than the distance between terminals.

### CROSS-REFERENCE TO RELATED APPLICATIONS

This application is a Continuation of PCT International Application No. PCT/JP2015/064183 filed on May 18, 2015, which claims priority under 35 U.S.C. §119(a) to Japanese Patent Application No. 2014-182412 filed on Sep. 8, 2014. The above application is hereby expressly incorporated by reference, in its entirety, into the present application.

### BACKGROUND OF THE INVENTION

1. Field of the Invention

The present invention relates to a conductive film for a touch panel and a touch panel, and particularly relates to a conductive film for a touch panel and a touch panel using a thin resin substrate. 2. Description of the Related Art

In recent years, touch panels which are used in combination with display devices such as liquid crystal display devices and perform an input operation to electronic device by touching a screen, in various electronic equipment such as portable information devices have come into wide use. In general, in a touch panel, a conductive film for a touch panel and a driving control circuit are connected to each other using flexible circuit substrates, for miniaturization, and a method of electrically connecting the conductive film for a touch panel and the flexible circuit substrate to each other by thermocompression bonding with an anisotropic conductive film interposed therebetween is used.

In recent years, it is required to provide thin touch panels, and the use of a thin resin substrate for a substrate of the conductive film for a touch panel has been considered in order to provide thin touch panels.

Here, fine electrodes respectively formed in the conductive film for a touch panel and the flexible circuit substrate are electrically connected to each other, and thus, there is a problem that electrical connection is not realized only due to slight deviation of positions of the electrodes. Therefore, a technology of reliably electrically connecting the conductive film for a touch panel and the flexible circuit substrate to each other has been developed.

JP2011-210176A, for example, discloses a touch panel in which a first bonded area is formed by performing pressure bonding of a first flexible circuit substrate to one surface side of a resin substrate, a second bonded area is formed by performing pressure bonding of a second flexible circuit substrate to the other surface side of the resin substrate, and the second bonded area is positioned in the first bonded area in a plan view. When the first flexible circuit substrate and the second flexible circuit substrate are disposed to be overlapped on each other as described above, it is possible to prevent deviation occurred in a position on the one surface side and the other surface side of the resin substrate to which pressure is applied, when performing thermocompression bonding of flexible circuit substrates on both surfaces of the resin substrate. Therefore, a difference in level is not generated in the conductive film for a touch panel due to the deviation of pressed positions and it is possible to realize excellent electric connection between the conductive film for a touch panel and flexible circuit substrates.

### SUMMARY OF THE INVENTION

However, when a thin resin substrate having a thickness equal to or smaller than 40 μm is used for the conducive film for a touch panel, in order to realize a thin touch panel, rigidity of the resin substrate significantly decreases. Accordingly, it is found that, when thermocompression bonding of a flexible circuit substrate 43 is performed on a surface of a conductive film for a touch panel 41 with an anisotropic conductive film 42 interposed therebetween, for example, as shown in FIG. 14A, portions of the resin substrate 44 of the conductive film for a touch panel 41, where external connection terminals 45 are disposed, are deformed to be recessed, as shown in FIG. 14B, electric connection between the external connection terminals 45 of the conductive film for a touch panel 41 and electrodes 46 of the flexible circuit substrate 43 is not obtained.

The invention is made to solve the aforementioned problems and an object thereof is to provide a conductive film for a thin touch panel having reliable electric connection with respect to flexible circuit substrates, and a thin touch panel.

According to the invention, there is provided a conductive film for a touch panel comprising: a flexible transparent resin substrate having a thickness equal to or smaller than 40 μm; a plurality of detection electrodes which are formed on at least one surface of the resin substrate; a plurality of peripheral wirings which are formed on at least one surface of the resin substrate and respectively connected to the plurality of detection electrodes; and a plurality of external connection terminals which are formed on at least one surface of the resin substrate and respectively connected to the plurality of peripheral wirings, in which the plurality of external connection terminals are arranged such that adjacent external connection terminals are separated from each other by a distance between terminals of 100 μm to 200 μm with a pitch equal to or smaller than 500 μm, and respectively have a terminal width equal to or greater than the distance between terminals.

Here, it is preferable that the terminal width of each of the plurality of external connection terminals is equal to or greater than a minimum width obtained by adding 50 μm to the distance between terminals and equal to or smaller than a maximum width obtained by adding 100 μm to the distance between terminals.

It is preferable that a coefficient of thermal shrinkage of the conductive film for a touch panel due to thermal treatment at 130° C. for 30 minutes is equal to or smaller than 0.20%.

The conductive film for a touch panel may further comprise: an insulating protective layer having a thickness of 20 μm to 150 μm which is formed on a surface of the resin substrate on a side opposite to the surface where the plurality of external connection terminals are formed, so as to correspond to a terminal formation area where the plurality of external connection terminals are formed.

It is preferable that the resin substrate is formed of polyethylene terephthalate or a cycloolefine polymer.

It is preferable that the plurality of detection electrodes have a mesh shape having an opening ratio equal to or greater than 90%.

The plurality of detection electrodes, the plurality of peripheral wirings, and the plurality of external connection terminals may be respectively formed on both surfaces of the resin substrate.

It is preferable that the external connection terminals which are present at the closest positions between the plurality of external connection terminals formed on one surface of the resin substrate and the plurality of external connection terminals formed on the other surface are disposed to be separated from each other by a distance equal to or greater than 300 μm in a direction along a plane direction of the resin substrate.

According to the invention, there is provided a touch panel comprising: the conductive film for a touch panel having any one of the configurations described above; a flexible circuit substrate on which a plurality of electrodes are formed; and an anisotropic conductive film which is disposed between the conductive film for a touch panel and the flexible circuit substrate, and connects the plurality of external connection terminals of the conductive film for a touch panel and the plurality of electrodes of the flexible circuit substrate to each other.

According to the invention, the plurality of external connection terminals are arranged to be separated from each other by the distance between terminals of 100 μm to 200 μm with the pitch equal to or smaller than 500 μm and respectively have the terminal width equal to or greater than the distance between terminals, in the conductive film for a touch panel using the resin substrate having a thickness equal to or smaller than 40 μm, and therefore, it is possible to reliably obtain electric connection with respect to the flexible circuit substrate.

### BRIEF DESCRIPTION OF THE DRAWINGS

FIG. 1 is a plan view showing a configuration of a conductive film for a touch panel according to Embodiment 1 of the invention.

FIG. 2 is a view showing a configuration of a mesh pattern of a detection electrode. FIG. 3 is a cross section view showing external connection terminals respectively formed on a front surface and a rear surface of a resin substrate.

FIG. 4 is a plan view showing a distance between terminals, a pitch, and a terminal width of the external connection terminals.

FIG. 5 is a cross section view showing insulating protective layers of a conductive film for a touch panel according to Embodiment 2.

FIG. 6 is a plan view showing an insulating protective layer formed on a rear surface of a resin substrate so as to correspond to first external connection terminals.

FIG. 7 is a plan view showing a modification example of the insulating protective layer formed on the rear surface of the resin substrate so as to correspond to the first external connection terminals.

FIG. 8 is a plan view showing insulating protective layers formed on a front surface of the resin substrate so as to correspond to second external connection terminals.

FIG. 9 is a plan view showing a modification example of the insulating protective layers formed on the front surface of the resin substrate so as to correspond to the second external connection terminals.

FIG. 10 is a cross section view showing a configuration of a touch panel according to the invention.

FIG. 11 is a cross section view showing a modification example of the touch panel.

FIG. 12 is a cross section view showing a case of manufacturing another modification example of the touch panel.

FIG. 13 is a cross section view showing still another modification example of the touch panel.

FIGS. 14A and 14B are cross section views showing a case of manufacturing a touch panel of the related art.

### DESCRIPTION OF THE PREFERRED EMBODIMENTS

Hereinafter, embodiments of the invention will be described with reference to the accompanying drawings.

Provided is a conductive film for a touch panel according to the invention including: a flexible transparent resin substrate having a thickness equal to or smaller than 40 μm; a plurality of detection electrodes which are formed on at least one surface of the resin substrate; a plurality of peripheral wirings which are formed on at least one surface of the resin substrate and respectively connected to the plurality of detection electrodes; and a plurality of external connection terminals which are formed on at least one surface of the resin substrate and respectively connected to the plurality of peripheral wirings, in which the plurality of external connection terminals are arranged to be separated from each other by a distance between terminals of 100 μm to 200 μm with a pitch equal to or smaller than 500 μm, and respectively have a terminal width equal to or greater than the distance between terminals.

[Conductive Film for Touch Panel]

### Embodiment 1

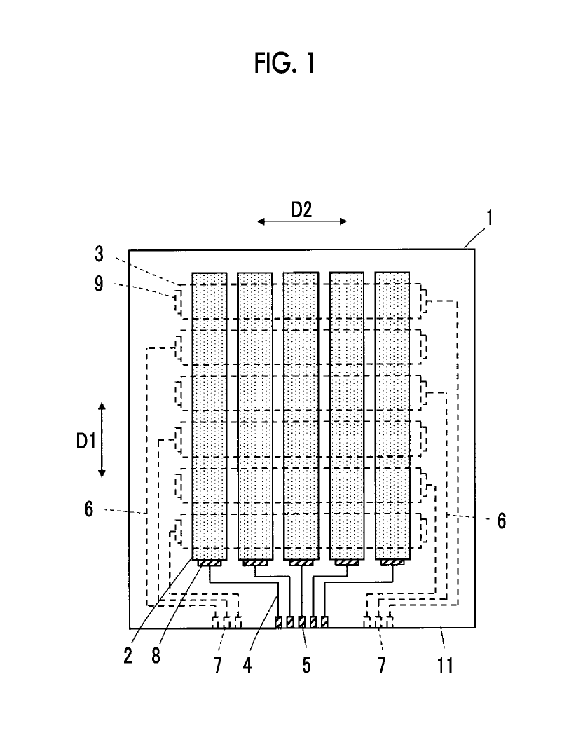

FIG. 1 shows a configuration of a conductive film for a touch panel according to Embodiment 1 of the invention. The conductive film for a touch panel includes a flexible and transparent resin substrate 1 having a thickness equal to or smaller than 40 μm, a plurality of first detection electrodes 2 are formed on a front surface of the resin substrate 1, and a plurality of second detection electrodes 3 are formed on a rear surface of the resin substrate 1. On a front surface of the resin substrate 1, a plurality of first peripheral wirings 4 corresponding to the plurality of first detection electrodes 2 are formed, and a plurality of first external connection terminals 5 connected to the plurality of first peripheral wirings 4 are formed on the edge of the resin substrate 1. In the same manner as described above, on the rear surface of the resin substrate 1, a plurality of second peripheral wirings 6 corresponding to the plurality of second detection electrodes 3 are formed, and a plurality of second external connection terminals 7 connected to the plurality of second peripheral wirings 6 are formed on the edge of the resin substrate 1.

The resin substrate 1 is a transparent substrate configured with a flexible resin material. The resin substrate 1 can be configured with, for example, polyesters such as polyethylene terephthalate (PET) and polyethylene naphthalate (PEN), polyolefins such as polyethylene (PE), polypropylene (PP), polystyrene, ethylene vinyl acetate (EVA), a cycloolefine polymer (COP), and a cycloolefine copolymer (COC), a vinyl resin, polycarbonate (PC), polyamide, polyimide, an acrylic resin, or triacetyl cellulose (TAC). The resin substrate 1 is preferably configured with polyethylene terephthalate or a cycloolefine polymer, from viewpoints of flexibility and optical characteristics. A term “transparent” means that transmittance of light in a visible range (wavelength of 400 nm to 800 nm) is equal to or greater than 80%.

The film thickness of the resin substrate 1 is equal to or smaller than 40 and the lower limit thereof is not particularly limited. The lower limit thereof is preferably equal to or greater than 15 when considering self-standing and handling properties of the conductive film for a touch panel.

An undercoat may be provided on one surface or both surfaces of the resin substrate 1, if necessary, in order to enhance adhesiveness between the detection electrodes, the peripheral wirings, and the external connection terminals formed on the resin substrate 1, in order to improve transmittance of the resin substrate 1, and in order to prevent light leakage of the rear surface at the time of exposure. The undercoat may be a single layer or may be a multilayer.

A coefficient of thermal shrinkage of the conductive film for a touch panel due to thermal treatment at 130° C. for 30 minutes is preferably equal to or smaller than 0.40% and particularly preferably equal to or smaller than 0.20%. Accordingly, when thermocompression bonding of the conductive film for a touch panel to a flexible circuit substrate is performed with an anisotropic conductive film interposed therebetween, for example, it is possible to prevent thermal deformation of the conductive film for a touch panel, prevent a deviation of positions of the first external connection terminals 5 and the second external connection terminals 7 formed on the front surface and the rear surface of the resin substrate 1, to prevent deviation of alignment thereof with respect to flexible circuit substrates, and to more reliably electrically connect the conductive film for a touch panel to flexible circuit substrates.

Here, the coefficient of thermal shrinkage due to the thermal treatment at 130° C. for 30 minutes can be acquired by heating the conductive film for a touch panel in a state of being placed flat in a dry oven at 130° C. for 30 minutes without tension, and measuring a dimensional between arbitrary two points of the conductive film for a touch panel before and after the heating. The measurement of the dimensional change is performed by using a pin gauging method. When a distance between arbitrary two points of the conductive film for a touch panel before heating is set as d1, and a distance between arbitrary two points of the conductive film for a touch panel after heating is set as d2, the coefficient of thermal shrinkage can be acquired using a calculation formula of coefficient of thermal shrinkage =|(d2−d1)/d1|×100(%).

A biaxial stretching polyethylene terephthalate is used as the resin substrate 1, the coefficient of thermal shrinkage may be different in a transverse direction (TD direction) and a machine direction (MD direction). In this case, a greater value of the coefficient of thermal shrinkage is used as the “coefficient of thermal shrinkage due to the thermal treatment at 130° C. for 30 minutes”.

The coefficient of thermal shrinkage of the conductive film for a touch panel, when thermal treatment at 130° C. for 30 minutes is performed, can be set to be equal to or smaller than 0.20%, by performing the thermal treatment with respect to the resin substrate 1 in advance, before forming conductive layers such as the detection electrodes, the peripheral wirings, and the external connection terminals on the resin substrate 1. A temperature of the thermal treatment is preferably 120 to 160 and the time of the thermal treatment is preferably 30 seconds to 10 minutes. It is preferable to perform the thermal treatment by applying tension to the resin substrate 1, in order to prevent warping of the resin substrate 1. However, when tension is excessively great, cracks may be generated on the resin substrate 1 having a film thickness equal to or smaller than 40 μm or the coefficient of thermal shrinkage thereof becomes great, and thus, the tension is preferably 5 to 20 N. Preferable ranges of the temperature, the time, and the tension of the thermal treatment vary depending on a material used and a film thickness of the resin substrate 1, and thus, it is preferable to suitably design the resin substrate, without limitation to the ranges described above, so that the coefficient of thermal shrinkage due to thermal treatment at 130° C. for 30 minutes becomes equal to or smaller than 0.20%.

(Detection Electrode)

The detection electrodes are electrodes for detecting a contact with a surface of a touch panel, and correspond to self-capacitance electrodes X and electrodes Y or mutual capacitance driving electrodes and detection electrodes in a projection type capacitive touch panel disclosed in JP2013-182548A.

As shown in FIG. 1, the plurality of first detection electrodes 2 are formed in an active area (light transmitting area) of a touch panel, and are respectively extended along a first direction D1 and disposed in parallel with a second direction D2 orthogonal to the first direction D1. A first connector portion 8 is formed on one end of each first detection electrode 2. Meanwhile, the plurality of second detection electrodes 3 are formed on an active area (light transmitting area) and are respectively extended along the second direction D2 and disposed in parallel with the first direction D1. A second connector portion 9 is formed on one end of each second detection electrode 3.

The first detection electrodes 2 and the second detection electrodes 3 can be formed with, for example, a transparent conductive metal oxide represented by indium tin oxide (ITO) and indium zinc oxide (IZO), a transparent polymer conductive material such as PEDOT-PSS and thiophene, a transparent conductive film of carbon nanotubes (CNT) and silver nanowires, or a mesh-like conductive layers formed with a mesh pattern formed of metal wires of silver, aluminum, copper, and gold.

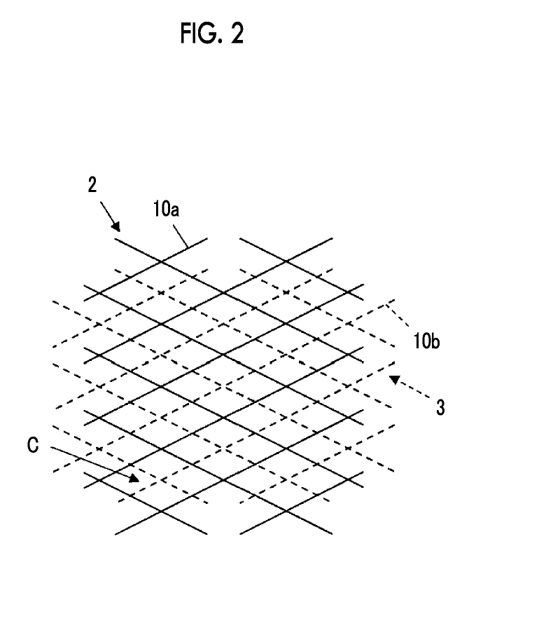

For example, as shown in FIG. 2, the first detection electrode 2 is preferably formed with a mesh pattern formed of thin metal wires 10a, and in the same manner, the second detection electrode 3 is also preferably formed with a mesh pattern formed of thin metal wires 10b. When the first detection electrode 2 and the second detection electrode 3 are formed with a mesh pattern as described above, it is possible to prevent stress applied to the resin substrate 1, compared to a case where plate-shaped detection electrodes are formed using ITO, for example. Therefore, it is possible to prevent deformation of the resin substrate 1 to be curled due to stress applied from the first detection electrode 2 and the second detection electrode 3, and prevent electric connection between the conductive film for a touch panel and flexible circuit substrates from being disturbed due to the deformation of the resin substrate 1.

Here, it is preferable that the first detection electrode 2 and the second detection electrode 3 are respectively formed of a mesh pattern having an opening ratio equal to or greater than 90%, so as to more reliably prevent stress applied to the resin substrate 1. When the first detection electrode 2 and the second detection electrode 3 are respectively formed of a mesh pattern having an opening ratio equal to or greater than 90%, an effect of decreasing parasitic capacitance in an intersection portion of the first detection electrode 2 and the second detection electrode 3 is also obtained. As the thickness of the resin substrate 1 decreases, parasitic capacitance in the intersection portion of the first detection electrode 2 and the second detection electrode 3 increases and sensitivity of a touch panel is deteriorated, but it is possible to effectively solve this problem by respectively forming the first detection electrode 2 and the second detection electrode 3 with a mesh pattern having an opening ratio equal to or greater than 90%.

The opening ratio is a proportion of an area of a cell C (opening) surrounded by the thin metal wires 10a or 10b with respect to the surface area of the first detection electrode 2 or the second detection electrode 3 (area of a region where the detection electrode is formed) and indicates a non-occupy rate of thin metal wires in the first detection electrode 2 or the second detection electrode 3.

The shape of the cell C may be a typical cell shape in which single cells C are repeatedly formed, or the cell C may have a random shape. In addition, the cell may have a semi-random shape obtained by applying certain random properties to the typical cell shape. In this case of the typical cell shape, the cell shape may be a square, a rhomboid, and a regular hexagon, a rhomboid is preferable, from a viewpoint of preventing moire, and an angle of an acute angle of the rhomboid is particularly preferably 20 degrees to 70 degrees. A cell pitch (distance between centers pf gravity of cells C adjacent to each other) is preferably 50 μm to 500 μm.

Although not shown, it is preferable to provide a dummy mesh pattern insulated from the first detection electrodes 2 and the second detection electrodes 3, between the plurality of first detection electrodes 2 and the plurality of second detection electrodes 3. The dummy mesh pattern is formed of thin metal wires, in the same manner as in the detection electrodes, and is formed with the same cell shape as that of the detection electrodes, in a case where the detection electrodes are configured with a typical cell shape. The dummy mesh pattern includes a disconnection portion having a length of 10 μm to 30 μm in the thin metal wires, in order to have insulating properties. When the dummy mesh pattern is provided as described above, an effect of reducing appearance of the pattern of the detection electrodes and appearance of the mesh of the thin metal wires when the conductive film for a touch panel is mounted on a touch panel is obtained.

In the mesh pattern of the first detection electrodes 2 and the mesh pattern of the second detection electrodes 3, it is preferable that the corner of the cell C of the mesh pattern of the second detection electrodes 3 is disposed at the center of the cell C of the mesh pattern of the first detection electrodes 2, when seen from the upper surface side, as shown in FIG. 2. When the mesh pattern of the first detection electrodes 2 and the mesh pattern of the second detection electrodes 3 are disposed as described above, it is possible to reduce appearance of the mesh of the thin metal wires. At this time, the opening ratio of the mesh pattern formed by combining the mesh pattern of the first detection electrodes 2 and the mesh pattern of the second detection electrodes 3 with each other is preferably equal to or greater than 90%, in viewpoints of visibility and preventing curling of the resin substrate 1.

As a material configuring the thin metal wires, metal such as silver, aluminum, copper, gold, molybdenum, or chromium, and alloy thereof can be used, and these can be used as a single layer or a laminate. A line width of the thin metal wires is preferably 0.5 μm to 5 μm, from a viewpoint of reducing appearance of the mesh of the thin metal wires and moire. The thin metal wires may have a linear, broken line, curved, or wave line shape. A film thickness of the thin metal wires is preferably equal to or smaller than 3 μm, from a viewpoint of visibility in an oblique direction. A blackened layer may be provided on a visible side of the thin metal wires, from a viewpoint of reducing appearance of mesh of the thin metal wires.

(Peripheral Wiring)

The plurality of first peripheral wirings 4 are formed in an inactive area (frame portion), and one ends thereof are respectively connected correspondingly to the plurality of first connector portions 8 formed on the plurality of first detection electrodes 2, and the other ends thereof are respectively connected correspondingly to the plurality of first external connection terminals 5.

The plurality of second peripheral wirings 6 are formed in an inactive area (frame portion), and ends thereof are respectively connected correspondingly to the plurality of second connector portions 9 formed on the plurality of second detection electrodes 3. At this time, the plurality of second peripheral wirings 6 are divided to be respectively disposed on one end sides and the other end sides of the plurality of second detection electrodes 3 so as to interpose the plurality of second detection electrodes 3, and the second peripheral wirings 6 disposed on the one end sides and the second peripheral wirings 6 disposed on the other end sides are alternately connected to the corresponding plurality of second connector portions 9 towards the first direction D1. The other ends of the plurality of second peripheral wirings 6 are respectively correspondingly connected to the plurality of second external connection terminals 7.

Here, in FIG. 1, the first detection electrodes 2 and the first peripheral wirings 4 are connected to each other through the first connector portions 8, but the first detection electrodes 2 and the first peripheral wirings 4 can be directly connected to each other without forming the first connector portions 8. In the same manner as described above, the second detection electrodes 3 and the second peripheral wirings 6 can be directly connected to each other without forming the second connector portions 9. It is preferable that the first connector portions 8 and the second connector portions 9 are provided, particularly, in a case where materials of the detection electrodes and the peripheral wirings are different from each other, because an effect of improving electric connection in a connected portion between the first detection electrodes 2 and the first peripheral wirings 4 and a connection portion between the second detection electrodes 3 and the second peripheral wirings 6 is obtained.

A material configuring the first peripheral wirings 4 and the second peripheral wirings 6 is preferably metal, and metal such as silver, aluminum, copper, gold, molybdenum, or chromium, and alloy thereof can be used, these can be used as a single layer or a laminate, or can be used as a laminate with the material configuring the detection electrodes. Among these configuration materials, it is preferable to use silver, from a viewpoint of resistance.

A minimum line width and a minimum gap of the first peripheral wirings 4 and the second peripheral wirings 6 are preferably 10 μm to 50 μm. As the minimum line width and the minimum gap of the first peripheral wirings 4 and the second peripheral wirings 6 is small, the area of the frame portion of the touch panel can be decreased. Accordingly, when the minimum line width and the minimum gap thereof is set to be equal to or greater than 10 μm, it is possible to prevent resistance insufficiency of the peripheral wirings to prevent a short circuit between the peripheral wirings.

A film thickness of the first peripheral wirings 4 and the second peripheral wirings 6 is preferably great, from a viewpoint of a resistance value, but when the film thickness thereof exceeds 50 μm, air bubbles are easily generated in an adhesive portion, when bonding a cover member which will be described later and the conductive film for a touch panel, and therefore, the film thickness thereof is preferably equal to or smaller than 50 μm. When air bubbles are generated in the adhesive portion, this causes peeling of the adhesive portion, and accordingly, when the generation of air bubbles are prevented, it is possible to prevent the peeling.

An insulating film formed of a urethane resin, an acrylic resin, and an epoxy resin may be provided so as to cover the upper portions of the first peripheral wirings 4 and the second peripheral wirings 6. When the insulating film is provided, it is possible to prevent migration and rust of the first peripheral wirings 4 and the second peripheral wirings 6.

(External Connection Terminal)

The plurality of first external connection terminals 5 and the plurality of second external connection terminals 7 are connected to flexible circuit substrates to be connected to a driving control circuit of the touch panel, and accordingly, as shown in FIG. 1, for example, the external connection terminals are formed in the inactive area (frame portion) and are formed to be arranged along one edge 11 of the resin substrate 1 facing the first connector portions 8. Here, as shown in FIG. 3, the plurality of first external connection terminals 5 are disposed at the center of one edge 11 on the front surface of the resin substrate 1 and the plurality of second external connection terminals 7 are disposed at positions on the rear surface of the resin substrate 1 which interposes the center where the first external connection terminals 5 are disposed. Accordingly, it is preferable that the plurality of first external connection terminals 5 and the plurality of second external connection terminals 7 are disposed on the front surface side and the rear surface side of the resin substrate 1 so as not to overlap each other. Therefore, it is possible to easily perform connection of flexible circuit substrates with respect to the plurality of first external connection terminals 5 and connection of flexible circuit substrates with respect to the plurality of second external connection terminals 7, respectively.

The plurality of first external connection terminals 5 are respectively connected correspondingly to the other ends of the plurality of first peripheral wirings 4 extending from the plurality of first connector portions 8. Among the plurality of second external connection terminals 7, the plurality of second external connection terminals 7 disposed on one end side of the second detection electrodes 3 are respectively connected correspondingly to the other ends of the plurality of second peripheral wirings 6 extending from the second connector portions 9 formed on one ends of the second detection electrodes 3, and the plurality of second external connection terminals 7 disposed on the other end side of the second detection electrodes 3 are respectively connected correspondingly to the other ends of the plurality of second peripheral wirings 6 extending from the second connector portions 9 formed on the other ends of the second detection electrodes 3.

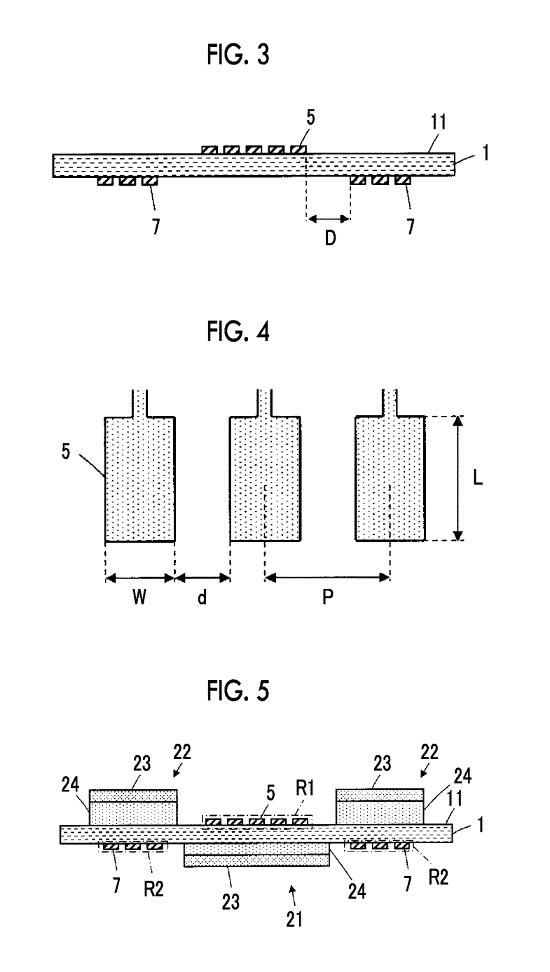

Here, as shown in FIG. 4, the plurality of first external connection terminals 5 are arranged to be separated from each other by a distance between terminals d of 100 μm to 200 μm with a pitch P equal to or smaller than 500 μm, and respectively formed so as to have a terminal width W equal to or greater than the distance between terminals d. In the same manner as described above, the plurality of second external connection terminals 7 are also arranged to be separated from each other by a distance between terminals d of 100 μm to 200 μm with a pitch P equal to or smaller than 500 μm, and respectively formed so as to have a terminal width W equal to or greater than the distance between terminals d. Here, the distance between terminals d can be defined as a shortest distance between external connection terminals adjacent to each other, the terminal width W can be defined as a maximum width of the external connection terminal in a direction in which the plurality of external connection terminals are arranged, and the pitch P can be defined as a distance between center lines of the external connection terminals adjacent to each other. The center line of the external connection terminal is defined as a line extending from a middle point of the maximum width of the external connection terminal in a direction in which the plurality of external connection terminals are arranged, in a direction orthogonal to the direction in which the external connection terminals are arranged. It is preferable that the first external connection terminals 5 and the second external connection terminals 7 are designed so as to have the same terminal width W with each other, disposed at intervals so as to have equivalent distance between terminals d with each other, and arranged at intervals so as to have equivalent pitch P with each other. However, in some parts of the first external connection terminals 5 and the second external connection terminals 7, the terminal width W, the distance between terminals d, or the pitch P may be different from each other, and in this case, the external connection terminals are designed so that the values thereof are included in the scope of the invention, and therefore, it is possible to obtain the effect of the invention.

When the layout of the plurality of first external connection terminals 5 and the plurality of second external connection terminals 7 is obtained within the ranges as described above, portions of the resin substrate 1 to which pressure is not directly applied, are decreased, when performing the thermocompression bonding of the conductive film for a touch panel to flexible circuit substrates with an anisotropic conductive film interposed therebetween, and therefore, pressure applied to the resin substrate 1 can be uniform in a plane direction. When pressure is applied to the resin substrate 1 in a wide range, when performing the thermocompression bonding of the conductive film for a touch panel to flexible circuit substrates with an anisotropic conductive film interposed therebetween, it is possible to prevent deformation of the resin substrate 1 and prevent short circuit between terminals adjacent to each other among the first external connection terminals 5 and the second external connection terminals 7 after the thermocompression bonding. By doing so, it is possible to prevent deformation of the resin substrate 1 and prevent electric connection between the conductive film for a touch panel and flexible circuit substrates from being disturbed due to the deformation of the resin substrate 1.

In addition, it is possible to keep the formation range of the plurality of first external connection terminals 5 and the plurality of second external connection terminals 7 in a narrow range of the resin substrate 1. Therefore, it is possible to prevent a deviation of positions of the plurality of first external connection terminals 5 and the plurality of second external connection terminals 7 and to prevent a deviation of alignment of the first external connection terminals 5 and the second external connection terminals 7 with respect to flexible circuit substrates, even when the resin substrate 1 is deformed due to thermal shrinkage, and it is possible to reliably electrically connect the conductive film for a touch panel to flexible circuit substrates.

A material configuring the first external connection terminals 5 and the second external connection terminals 7 is preferably metal, and metal such as silver, aluminum, copper, gold, molybdenum, or chromium, and alloy thereof can be used, these can be used as a single layer or a laminate, or can be used as a laminate with the material configuring the detection electrodes. Among these configuration materials, it is preferable to use silver and copper, from a viewpoint of electric connection properties with flexible circuit substrates.

A film thickness of the first external connection terminals 5 and the second external connection terminals 7 is preferably 0.1 μm to 10 μm, from a viewpoint of electric connection properties with flexible circuit substrates. It is not preferable that the film thickness thereof is smaller than 0.1 μm, because the melting of conductive particles included in an anisotropic conductive film may be insufficiently performed when performing the thermocompression bonding of the conductive film for a touch panel to flexible circuit substrates, and the electric connection with flexible circuit substrates may decrease. It is not preferable that the film thickness thereof exceeds 10 μm, because conductive particles included in an anisotropic conductive film may break electrodes of flexible circuit substrates to cause a degradation in the electric connection.

A length L of the first external connection terminals 5 and the second external connection terminals 7 shown in FIG. 4 is preferably 0.5 mm to 1.5 mm. When the length L thereof is equal to or smaller than 1.5 mm, it is possible to realize a narrow frame portion of a touch panel, and when the length L thereof is equal to or greater than 0.5 mm, it is possible to more reliably electrically connect the conductive film for a touch panel with a flexible circuit substrate. A shortest distance from the edge of the resin substrate 1 to the external connection terminals is preferably 0.02 mm to 1.0 mm.

It is preferable that the first external connection terminals 5 and the second external connection terminals 7 are configured with the same material as that of the first peripheral wirings 4 and the second peripheral wirings 6 and manufactured in the same step at the same time.

Here, it is preferable that the terminal width W of the plurality of first external connection terminals 5 and the plurality of second external connection terminals 7 is equal to or greater than a minimum width obtained by adding 50 μm to the distance between terminals d and equal to or smaller than a maximum width obtained by adding 100 μm to the distance between terminals d. Accordingly, when performing the thermocompression bonding of the conductive film for a touch panel to flexible circuit substrates with an anisotropic conductive film interposed therebetween, it is possible to prevent a deviation of positions by keeping the formation range of the plurality of first external connection terminals 5 and the plurality of second external connection terminals 7 in a predetermined range, while applying pressure to the wide range of the resin substrate 1. Therefore, it is possible to more reliably electrically connect the conductive film for a touch panel to flexible circuit substrates.

It is preferable that the plurality of first external connection terminals 5 formed on the front surface of the resin substrate 1 and the plurality of second external connection terminals 7 formed on the rear surface thereof are disposed to be separated from each other by a distance D equal to or greater than 300 μm along the plane direction of the resin substrate 1 (shortest distance between the first external connection terminal 5 and the second external connection terminal 7 in the plane direction of the resin substrate 1), as shown in FIG. 3. When performing the thermocompression bonding of the conductive film for a touch panel to flexible circuit substrates with an anisotropic conductive film interposed therebetween, a flexible circuit substrate to be connected to the plurality of first external connection terminals 5 is pressure-bonded to the rear surface side from the front surface side of the resin substrate 1, whereas a flexible circuit substrate to be connected to the plurality of second external connection terminals 7 is pressure-bonded to the front surface side from the rear surface side of the resin substrate 1. Accordingly, when the distance D between the plurality of first external connection terminals 5 and the plurality of second external connection terminals 7 is less than 300 μm, pressure opposing each other may be applied to portions of the resin substrate 1 adjacent to each other and a difference in level may be generated on the resin substrate 1. This a difference in level causes a deviation of positions of the first external connection terminals 5 and the second external connection terminals 7 and becomes a reason of the breakage of the resin substrate 1 in a step of bonding a cover member which will be described later and the conductive film for a touch panel or the subsequent step thereof. When the resin substrate 1 is broken, moisture or oxygen penetrates through the broken portion and quality of the external connection terminals or the peripheral wirings are deteriorated. Therefore, when the distance D between the plurality of first external connection terminals 5 and the plurality of second external connection terminals 7 is equal to or greater than 300 μm, it is possible to disperse pressure applied to the resin substrate 1 in directions opposing each other to prevent generation of a difference in level on the resin substrate 1. Thus, in the subsequent step, the possibility of breaking the resin substrate 1 can be decreased, and therefore, it is possible to provide a conductive film having a touch panel and a touch panel having high reliability. A maximum value of the distance D between the plurality of first external connection terminals 5 and the plurality of second external connection terminals 7 is not particularly limited and is preferably equal to or smaller than 3,000 μm, from a viewpoint of realizing a narrow frame portion.

Although not shown, dummy external connection terminals or external connection terminals connected to shielding wirings may be provided between the first external connection terminals 5 and the second external connection terminals 7 or on the outer side of the second external connection terminals 7. The dummy external connection terminals or the external connection terminals connected to shielding wirings may be formed on the front surface where the first external connection terminals 5 are formed or on the rear surface where the second external connection terminals 7 are formed, and the dummy external connection terminals or the external connection terminals connected to shielding wirings are preferably disposed to be separated from each other by the distance D equal to or greater than 300 μm along the plane direction of the resin substrate 1 in the orthogonal plane orthogonal to the resin substrate 1.

A manufacturing method of the conductive film for a touch panel is not particularly limited, and manufacturing methods disclosed in JP2011-129501A, JP2013-149236A, JP2014-112512A, JP2011-513846A, JP2014-511549A, JP2013-186632A, and JP2014-85771A can be used, for example. Among these, a manufacturing method of a conductive film of exposing and developing a photosensitive silver halide emulsion layer to form a conductive pattern in which a conductive portion is formed of metal silver, disclosed in JP2012-6377A is preferable, because steps can be simplified.

Here, it is preferable that the first detection electrodes 2, the first connector portions 8, the first peripheral wirings 4, and the first external connection terminals 5 are configured with the same metal material. In the same manner as described above, it is preferable that the second detection electrodes 3, the second connector portions 9, the second peripheral wirings 6, and the second external connection terminals 7 are configured with the same metal material. When the first detection electrodes 2, the first connector portions 8, the first peripheral wirings 4, and the first external connection terminals 5 are configured with the same metal material as described above, the first detection electrodes 2, the first connector portions 8, the first peripheral wirings 4, and the first external connection terminals 5 can be manufactured in the same step at the same time, and thus, it is possible to omit an alignment step or the like and the steps can be simplified. Since deformation easily occurs in the substrate between the steps and a deviation of alignment may occur in the resin substrate 1 having a film thickness equal to or smaller than 40 μm, it is preferable to manufacture the above-mentioned components in the same step at the same time, because a deviation of alignment can be prevented. In the same manner as described above, when the second detection electrodes 3, the second connector portions 9, the second peripheral wirings 6, and the second external connection terminals 7 are configured with the same metal material, the second detection electrodes 3, the second connector portions 9, the second peripheral wirings 6, and the second external connection terminals 7 can also be manufactured in the same step at the same time. As described above, the first connector portions 8 and the second connector portions 9 are not compulsorily necessary, and thus, may not be provided in some cases.

In a case where the first detection electrodes 2, the first connector portions 8, the first peripheral wirings 4, and the first external connection terminals 5 are configured with the same metal material and the second detection electrodes 3, the second connector portions 9, the second peripheral wirings 6, and the second external connection terminals 7 are configured with the same metal material, these are preferably configured with silver or copper, from viewpoints of a resistance value and visibility. A film thickness of the first detection electrodes 2, the first connector portions 8, the first peripheral wirings 4, and the first external connection terminals 5 and a film thickness of the second detection electrodes 3, the second connector portions 9, the second peripheral wirings 6, and the second external connection terminals 7 are preferably 0.1 μm to 3 μm, from viewpoints of the resistance and visibility.

In the embodiment, the first detection electrodes 2, the first peripheral wirings 4, and the first external connection terminals 5 are disposed on the front surface of the resin substrate 1 and the second detection electrodes 3, second peripheral wirings 6, and the second external connection terminals 7 are disposed on the rear surface of the resin substrate 1, but the detection electrodes, the peripheral wirings, and the external connection terminals may be disposed on at least one surface of the resin substrate 1, and there is no limitation.

In FIG. 1, the first detection electrodes 2 are arranged to have five columns and the second detection electrodes 3 are arranged to have six columns, but the number of the first detection electrodes 2 and the number of the second detection electrodes 3 are not limited.

### Embodiment 2

An insulating protective layer having a thickness of 20 μm to 150 μm can be further formed on the rear surface of the resin substrate 1 on a side opposite to the front surface where the plurality of first external connection terminals 5 are formed, so as to correspond to a terminal formation area where the plurality of first external connection terminals 5 are formed. In the same manner as described above, an insulating protective layer having a thickness of 20 μm to 150 μm can also be formed on the front surface of the resin substrate 1 on a side opposite to the rear surface where the plurality of second external connection terminals 7 are formed, so as to correspond to a terminal formation area where the plurality of second external connection terminals 7 are formed.

When the insulating protective layers are formed as described above, it is possible to further effectively decrease deformation of the resin substrate 1, when performing the thermocompression bonding of the conductive film for a touch panel to flexible circuit substrates with an anisotropic conductive film interposed therebetween. It is not preferable that a thickness of the insulating protective layer is less than 20 μm, because an effect of preventing deformation of the resin substrate 1 at the time of thermocompression bonding is poor, and it is not preferable that a thickness of the insulating protective layer exceeds 150 μm, because the resin substrate 1 is wrapped due to the insulating protective layers and alignment at the time of thermocompression bonding is difficult.

When the insulating protective layer is configured with two layers of a protective layer and an adhesive portion and the protective layer is configured with the same resin material as that of the resin substrate 1, coefficients of thermal expansion of the resin substrate 1 and the protective layer are the same as each other, and therefore, it is possible to further effectively decrease deformation of the resin substrate 1 at the time of thermocompression bonding.

As shown in FIG. 5, a first insulating protective layer 21 can be formed on the rear surface of the resin substrate 1 so as to correspond to a terminal formation area R1 where the first external connection terminals 5 are formed, and a second insulating protective layer 22 can be formed on the front surface of the resin substrate 1 so as to correspond to a terminal formation area R2 where the second external connection terminals 7 are formed.

The first insulating protective layer 21 and the second insulating protective layer 22 are for respectively supporting and protecting the resin substrate 1 from the deformation, and accordingly, each of the insulating protective layers is preferably configured with a protective portion 23 and an adhesive portion 24 which is disposed between the protective portion 23 and the resin substrate 1. It is preferable that the protective portion 23 is configured with the same resin material as that of the resin substrate 1. When the protective portion is configured with the same resin material as that of the resin substrate 1, coefficients of thermal expansion of the resin substrate 1 and the protective portion becomes the same as each other, and therefore, it is possible to further effectively decrease deformation of the resin substrate 1 at the time of thermocompression bonding. The adhesive portion 24 includes an adhesive, and this adhesive can be selected from an acrylic resin type, a urethane resin type, a silicone resin type, a rubber type, an ethylene-vinyl acetate copolymer (EVA), low density polyethylene (LDPE), and very low density polyethylene (VLDPE). The adhesive portion 24 is preferably configured with an optical clear adhesive (OCA) including an acrylic resin type adhesive. When the adhesive portion 24 is configured with an optical clear adhesive (OCA), it is possible to use the optical clear adhesive (OCA) as an adhesive layer used in bonding with another member, by peeling off the protective portion 23 in a step after a pressure-bonding step performed with respect to flexible circuit substrates, and simplification of the steps and a decrease in the number of members can be realized.

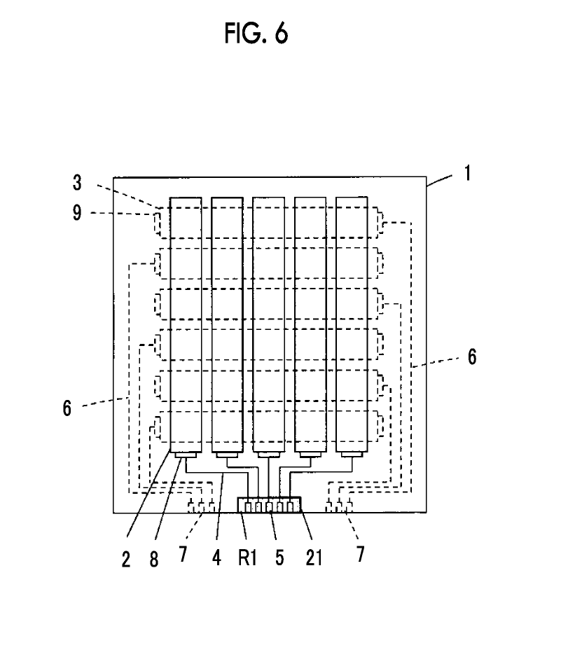

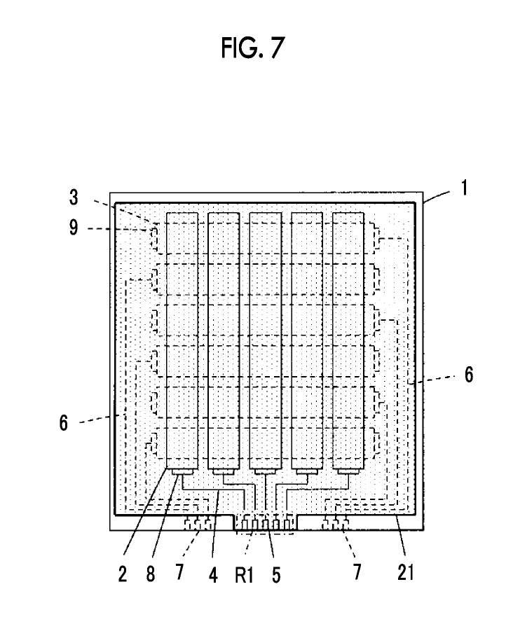

The first insulating protective layer 21 can be formed so as to correspond to a predetermined area including the terminal formation area R1 where the first external connection terminals 5 are formed, and as shown in FIG. 6, for example, the first insulating protective layer can be formed to correspond only to the terminal formation area R1 where the first external connection terminals 5. As shown in FIG. 7, the first insulating protective layer 21 can also be formed over the entire surface of the area including components except for the second external connection terminals 7. This case is preferable because the first insulating protective layer 21 can support and protect the resin substrate 1 from the deformation and can also serve as a protective film which protects the second detection electrodes 3, the second connector portions 9, and the second peripheral wirings 6.

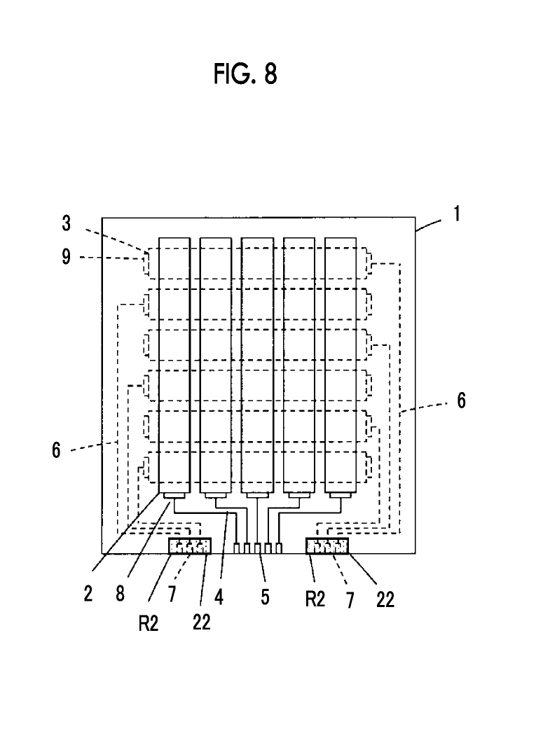

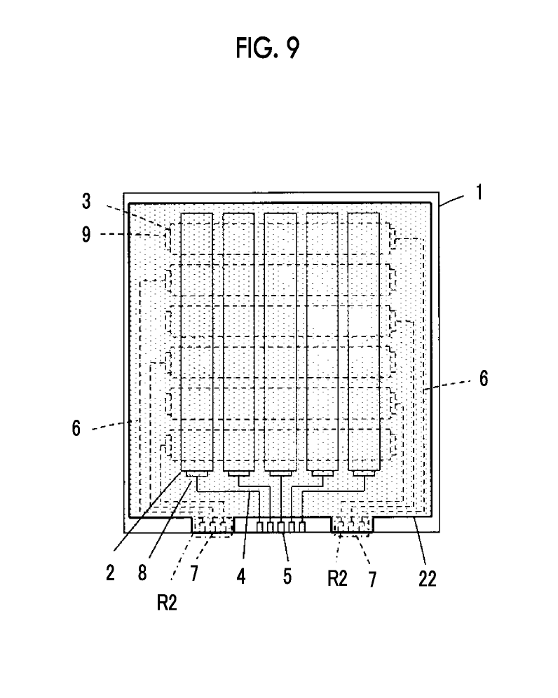

In the same manner as described above, the second insulating protective layer 22 can be formed so as to correspond to a predetermined area including the terminal formation area R2 where the second external connection terminals 7 are formed, and as shown in FIG. 8, for example, the second insulating protective layer can be formed to correspond only to the terminal formation area R2 where the second external connection terminals 7 are formed. As shown in FIG. 9, the second insulating protective layer 22 can also be formed over the entire surface of the area including components except for the first external connection terminals 5. This case is preferable because the second insulating protective layer 22 can support and protect the resin substrate 1 from the deformation and can also serve as a protective film which protects first detection electrodes 2, the first connector portions 8, and the first peripheral wirings 4.

The second insulating protective layer 22 shown in FIG. 9 is preferably configured with two layers of the protective film 23 and the adhesive portion 24 as described above. Particularly, the adhesive portion 24 is preferably configured with an optical clear adhesive (OCA). The case of this configuration is preferable because the bonding can be performed with an optical clear adhesive (OCA) which is the adhesive portion 24, when bonding a cover member which will be described later and the conductive film for a touch panel, and therefore, it is possible to simplify the configuration of the adhesive portion 24 and the bonding step while preventing the deformation of the resin substrate 1.

[Touch Sensor Film]

Next, a touch panel according to the invention will be described in detail. This touch panel can be configured with the conductive film for a touch panel described above, a flexible circuit substrate on which a plurality of electrodes are formed, and an anisotropic conductive film which is disposed between the conductive film for a touch panel and the flexible circuit substrate and connects a plurality of external connection terminals of the conductive film for a touch panel and a plurality of electrodes of the flexible circuit substrate to each other.

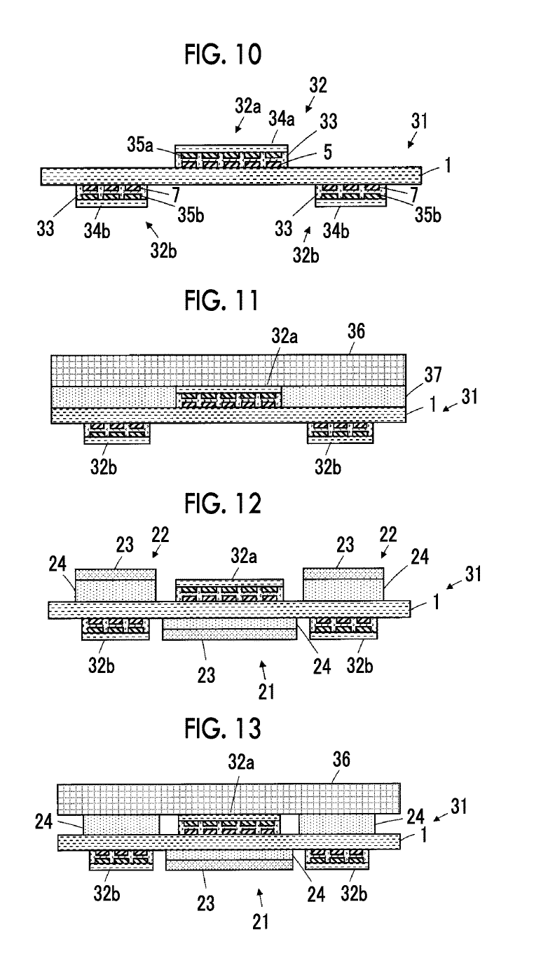

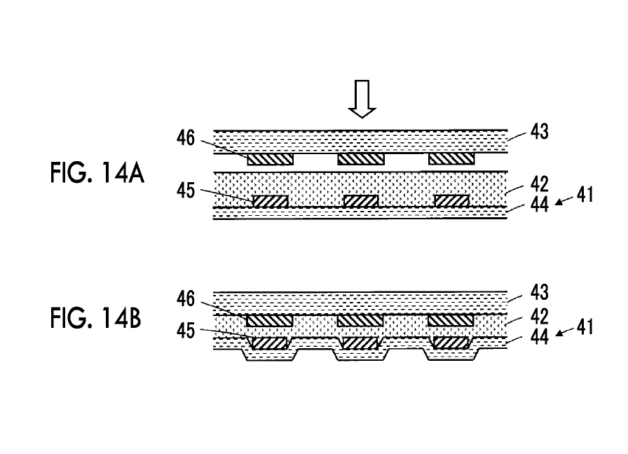

For example, as shown in FIG. 10, the touch panel can be configured with a conductive film for a touch panel 31, a flexible circuit substrate 32 which is disposed to face the conductive film for a touch panel 31, and an anisotropic conductive film 33 which is disposed between the conductive film for a touch panel 31 and the flexible circuit substrate 32.

The flexible circuit substrate 32 includes a first flexible circuit substrate 32a which is disposed so as to correspond to the first external connection terminals 5 of the conductive film for a touch panel 31, and a second flexible circuit substrate 32b which is disposed so as to correspond to the second external connection terminals 7. The first flexible circuit substrate 32a includes a first flexible substrate 34a, and a plurality of first electrodes 35a disposed on the surface of the first flexible substrate 34a facing the first external connection terminals 5, and the second flexible circuit substrate 32b includes a second flexible substrate 34b, and a plurality of second electrodes 35b disposed on the surface of the second flexible substrate 34b facing the second external connection terminals 7.

The anisotropic conductive film 33 bonds the conductive film for a touch panel 31 and the first flexible circuit substrate 32a to each other by using thermocompression bonding, electrically connects the plurality of first external connection terminals 5 of the conductive film for a touch panel 31 and the plurality of first electrodes 35a of the first flexible circuit substrate 32a to each other, bonds the conductive film for a touch panel 31 and the second flexible circuit substrate 32b to each other, and electrically connects the plurality of second external connection terminals 7 of the conductive film for a touch panel 31 and the plurality of second electrodes 35b of the second flexible circuit substrate 32b to each other.

In the touch panel, the first external connection terminals 5 of the conductive film for a touch panel 31 are arranged to be separated from each other by the distance between terminals d of 100 μm to 200 μm with a pitch P equal to or smaller than 500 μm, and have the terminal width W equal to or greater than the distance between terminals d. In the same manner as described above, the second external connection terminals 7 are also arranged to be separated from each other by the distance between terminals d of 100 μm to 200 μm with a pitch P equal to or smaller than 500 μm, and have the terminal width W equal to or greater than the distance between terminals d. Accordingly, it is possible to reliably electrically connect the conductive film for a touch panel 31 and the flexible circuit substrate 32 to each other, when thermocompression bonding of the conductive film for a touch panel 31 and the flexible circuit substrate 32 is performed with the anisotropic conductive film 33 interposed therebetween.

(Flexible Circuit Substrate)

The flexible circuit substrate 32 used in the invention includes an insulating flexible substrate and electrodes formed on the surface of the flexible substrate. As the flexible circuit substrate 32, a substrate which is generally used for the connection with the conductive film for a touch panel 31 in which the detection electrodes and the external connection terminals are formed on the resin substrate can be used. The electrodes of the flexible circuit substrate 32 are connected to a touch panel driving control circuit.

Specifically, as the electrodes of the flexible circuit substrate 32, electrodes including surface side connection terminals formed on one surface of the flexible substrate and rear side connection terminals formed on the other surface of the flexible substrate can be used.

The flexible substrate of the invention is not particularly limited, as long as it has desired insulating properties, and can be configured with a flexible polyimide film having a thickness of approximately 25 μm, for example. Among these, the flexible substrate having a coefficient thermal shrinkage at a pressure-bonding temperature at the time of pressure bonding which is the same as that of the conductive film for a touch panel 31 is particularly preferable, because it is possible to prevent a deviation of alignment at the time of pressure bonding. The electrodes of the flexible circuit substrate 32 are not particularly limited, as long as it has desired conductivity, and can be configured with metal such as silver, aluminum, copper, gold, molybdenum, or chromium, and alloy thereof, and these can be used as a single layer or a laminate.

The flexible circuit substrate 32 of the invention includes the flexible substrate and the electrodes, but may have other configurations, if necessary. As the other configurations, wirings connected to the electrodes or a protective layer formed so as to cover the wirings can be used, for example. The protective layer is not particularly limited, as long as insulating properties are obtained, and a protective layer formed of a polyimide resin can be used, for example.

(Anisotropic Conductive Film)

The anisotropic conductive film 33 is formed of an anisotropic conductive material showing adhesiveness and conductivity in a thickness direction by performing thermocompression bonding, and connects the external connection terminals of the conductive film for a touch panel 31 and the electrodes of the flexible circuit substrate 32 to each other.

The anisotropic conductive film 33 preferably has a configuration of a film shape in which conductive particles are dispersed in an insulating binder. The conductive particles are not particularly limited as long as those have desired conductivity, and metal particles such as gold, silver, or nickel, or metal-coated particles in which a metal coating film of nickel or gold is formed on a surface of ceramic, plastic, or metal particles using the particles as a nuclear, can be used. As the material of the insulating binder, an epoxy resin can be used, for example. A particle diameter of the conductive particles is preferably 5 μm to 15 μm. When the particle diameter of the conductive particles which is in the range of the invention is used, it is possible to effectively prevent short circuit between external connection terminals, while ensuring excellent electric connection between the conductive film for a touch panel 31 and the flexible circuit substrate 32.

Here, it is preferable that the first electrodes 35a and the second electrodes 35b have a thickness which is ¼ to ½ with respect to the thickness of the resin substrate 1. When the first electrodes 35a and the second electrodes 35b are formed to be thin as described above, it is possible to prevent an amount of the flexible circuit substrate 32 indented to the conductive film for a touch panel 31 at the time of thermocompression bonding, and prevent electric connection between the conductive film for a touch panel 31 and the flexible circuit substrate 32 from being disturbed due to the deformation of the resin substrate 1 to be recessed.

It is preferable that the touch panel further includes a cover member 36 which covers the entire surface of the conductive film for a touch panel 31 and an adhesive portion 37 which bonds the cover member 36 and the resin substrate 1 to each other. When covering the conductive film for a touch panel with the cover member 36 as described above, it is possible to protect the conductive film for a touch panel 31 and the flexible circuit substrate 32. The cover member 36 can be configured with a glass material such as tempered glass, soda glass, and sapphire or a resin material such as polymethyl methacrylate (PMMA) and polycarbonate (PC), for example.

It is possible to easily provide the cover member 36 by using the conductive film for a touch panel according to Embodiment 2. First, as shown in FIG. 12, the thermocompression bonding of the first flexible circuit substrate 32a and the second flexible circuit substrate 32b are is performed with respect to the conductive film for a touch panel 31 with the anisotropic conductive film 33 interposed therebetween, and accordingly, the conductive film for a touch panel 31 and the first flexible circuit substrate 32a are electrically connected to each other and the conductive film for a touch panel 31 and the second flexible circuit substrate 32b are electrically connected to each other.

Here, the adhesive portion 24 of the second insulating protective layer 22 has a thickness so as to have a height position higher than the height position of the first flexible circuit substrate 32a attached to the front surface side of the conductive film for a touch panel 31, and can be formed with a thickness of 50 μm, for example. The protective portion 23 of the second insulating protective layer 22 can be formed with a thickness of 25 and the adhesive portion 24 and the protective portion 23 of the first insulating protective layer 21 can be respectively formed with a thickness of 25 μm.

Regarding the second insulating protective layer 22, the adhesive portion 24 can be exposed by only peeling off the protective portion 23, and as shown in FIG. 13, the cover member 36 can be bonded to the surface of the conductive film for a touch panel 31 with the exposed adhesive portion 24 interposed therebetween.

As described above, the adhesive portion 24 has a function of not only supporting and protecting the resin substrate 1 from the deformation but also bonding the resin substrate, and accordingly, the cover member 36 can be easily bonded to the surface of the conductive film for a touch panel 31 by only peeling off the protective portion 23, after attaching the flexible circuit substrates 32 to the conductive film for a touch panel 31.

The configuration of the touch panel is not limited to the configuration shown in this specification, and touch panels having a configuration in which an insulating film is only provided in an intersection portion of electrodes and connection is performed with bridge wirings formed on the insulating film, as disclosed in JP2010-16067A, and a configuration in which detection electrodes are only provided on one side of the substrate like an electrode configuration without an intersection portion, disclosed in US2012/0262414 can be used, for example. A touch panel configured by bonding two sheets of the conductive film for a touch panel including the detection electrodes, the peripheral wirings, and the external connection terminals only on one surface of the resin substrate 1 can be applied.

### EXAMPLES

Hereinafter, the invention will be described in detail with reference to the examples. The materials, the usage amount, the ratio, the process content, and the process procedure shown in the following examples can be suitably changed within a range not departing from the gist of the invention. Therefore, the ranges of the invention are not narrowly interpreted based on the examples shown below.

### Example 1

The surface hydrophilizing was performed by corona discharge treatment with respect to a surface of a sheet formed of polyethylene terephthalate (PET) having a thickness of 38 μm which is subjected to thermal treatment at 150° C. for 3 minutes while applying tension of 20 N, and a resin substrate was manufactured. Then, first detection electrodes, first peripheral wirings, and first external connection terminals configured with Ag films having a film thickness of 1μm were formed on a front surface of the resin substrate by using a pattern formation method shown below, and a conductive film for a touch panel was manufactured. Here, the first external connection terminals were arranged to be separated from each other by the distance between terminals d of 100 μm with the pitch P of 300 μm, and the terminal width W thereof was respectively 200 μm. The first detection electrodes were formed to have a mesh shape (cell pitch: 300 μm) having a line width of 3 μm and an opening ratio of 98 and formed of typical cells of a rhomboid having an angle of an acute angle of 60°, the first peripheral wirings were formed with a line width of 20 μm and the minimum gap of 20 μm, and the first external connection terminals were formed with the length L of 1 mm.

When the thermal treatment at 130° C. for 30 minutes was performed with respect to the conductive film for a touch panel manufactured, a coefficient of thermal shrinkage was 0.16%.

Then, the thermocompression bonding of flexible circuit substrates obtained by forming electrodes formed of copper having a thickness of 12 μm on a surface of a substrate formed of polyimide having a thickness of 25 μm was performed with respect to the conductive film for a touch panel at 130° C. for 20 seconds, with an anisotropic conductive film having a particle diameter of conductive particles of 10 μm (CP920AM-16AC: Dexerials Corporation interposed therebetween, and a touch panel was manufactured.

<Pattern Formation Method>

(Preparation of Silver Halide Emulsion)

Amounts of a 2 solution and a 3 solution below corresponding to 90% were added to a 1 solution below held at 38° C. and pH of 4.5 for 20 minutes while being stirring, and nuclear particles having a diameter of 0.16 μm were formed. Then, a 4 solution and a 5 solution below were added thereto for 8 minutes, and the amounts of the remaining 10% of the 2 solution and the 3 solution below were added thereto for 2 minutes, and the particles were caused to grow to have a diameter of 0.21 μm. 0.15 g of potassium iodide was added thereto, aging was performed for 5 minutes, and particle formation was finished.

1 solution:
Water: 750 ml
Gelatin: 9 g
Sodium chloride: 3 g
1,3-dimethyl-2-thione: 20 mg
Sodium benzenethiosulfonate: 10 mg
Citric acid: 0.7 g

2 solution:
Water: 300 ml
Silver nitrate: 150 g

3 solution:
Water: 300 ml
Sodium chloride: 38 g
Potassium bromide: 32 g
Potassium hexachloroiridate (III) (0.005% of KCl and 20% of aqueous solution): 8 ml
Ammonium hexachlorinated rhodiumate (0.001% of NaCl and 20% of aqueous solution): 10 ml

4 solution:
Water: 100 ml
Silver nitrate: 50 g

5 solution:
Water: 100 ml
Sodium chloride: 13 g
Potassium bromide: 11
Yellow prussiate of potash: 5 mg

After that, washing was performed using a flocculation method according to the usual method. Specifically, the temperature was decreased to 35° C. and pH was decreased using sulfuric acid until silver halide is precipitated (pH was in a range of 3.6±0.2). Then, approximately 3 liters of the supernatant was removed (first washing). After adding 3 liters of distilled water, sulfuric acid was added until silver halide is precipitated. 3 liters of the supernatant was removed again (second washing). The same operation as the second washing was further repeated one more time (third washing) and a washing and desalting step was finished. The pH of the emulsion after washing and desalting was adjusted to 6.4 and the pAg thereof was adjusted to 7.5, 3.9 g of gelatin, 10 mg of sodium benzenethiosulfonate, 3 mg of sodium benzenethiosulfinate, 15 mg of sodium thiosulfate, and 10 mg of chloroauric acid were added thereto, chemosensitization was performed so as to obtain optimal sensitivity at 55° C., 100 mg of 1,3,3a,7-tetraazaindene as a stabilizer and 100 mg of PROXEL (product name, manufactured by ICI Co., Ltd.) as a preservative were added thereto. The emulsion finally obtained was a iodide salt silver bromide cubic grain emulsion containing 0.08 mol % of silver iodide, in which a proportion of silver chlorobromide was set so that a proportion of silver chloride is 70 mol % and a proportion of silver bromide is 30 mol %, an average particle diameter is 0.22 μm, and a coefficient of variation is 9%.

(Preparation of Composition for Forming Photosensitive Layer)

1.2×10⁻⁴ mol/mol Ag of 1,3,3a,7-tetraazaindene, 1.2×10⁻² mol/mol Ag of hydroquinone, 3.0×10⁻⁴ mol/mol Ag of citric acid, and 0.90 g/mol Ag of 2,4-dichloro-6-hydroxy-1,3,5-triazine sodium salt were added to the emulsion described above, the pH of the coating solution was adjusted to 5.6 using citric acid, and a composition for forming a photosensitive layer was obtained.

(Photosensitive Layer Formation Step)

A gelatin layer having a thickness of 0.1 μm as an undercoat was provided on the surface of the resin substrate, and an antihalation layer containing a dye which has an optical density of approximately 1.0 and is decolored due to alkali of a developer was further provided on the undercoat. The composition for forming a photosensitive layer was applied onto the antihalation layer, a gelatin layer having a thickness of 0.15 μm was further provided, and the resin substrate including photosensitive layers formed on the surface thereof was obtained. The resin substrate including photosensitive layers formed on the surface thereof is set as a film A. Regarding the photosensitive layers formed, an amount of silver was 6.0 g/m² and an amount of gelatin was 1.0 g/m².

(Exposure and Development Step)

The exposure of the surface of the film A was performed using parallel light using a high pressure mercury lamp as a light source through a photo mask so as to form the first detection electrodes, the first peripheral wirings, and the first external connection terminals of FIG. 1 described above. After the exposure, the development was performed using a developer below and a development process was performed using a fixing solution (product name: N3X-R for CN16X manufactured by Fujifilm Corporation). Then, resin substrate was rinsed with pure water and dried, and accordingly, a resin substrate in which the first detection electrodes, the first peripheral wirings, and the first external connection terminals formed of thin Ag wires, and the gelatin layers are formed on the surface was obtained. The gelatin layers were formed between the thin Ag wires. The film obtained was set as a film B.

(Composition of Developer)

The following compounds are included in 1 liter (L) of the developer.
Hydroquinone: 0.037 mol/L
N-methylaminophenol: 0.016 mol/L
Sodium metaborate: 0.140 mol/L
Sodium hydroxide: 0.360 mol/L
Sodium bromide: 0.031 mol/L
Potassium metabisulfite: 0.187 mol/L

(Heating Step)

The film B was placed in a superheated vapor tank at 120° C. for 130 seconds to perform the heating process. The film after the heating process was set as a film C.

(Gelatin Decomposing Process)

The film C was dipped in an aqueous solution of a proteolytic enzyme (BIOPLASE AL-15FG manufactured by Nagase ChemteX Corporation) (concentration of proteolytic enzyme: 0.5% by mass, solution temperature: 40° C.) for 120 seconds. The film C was extracted from the aqueous solution and dipped in warm water (solution temperature: 50° C.) for 120 seconds, and then washed. The film after the gelatin decomposing process was set as a film D. The film D was set as a conductive film for a touch panel.

### Example 2

A touch panel was manufactured by the same method as that in Example 1, except for arranging the first external connection terminals to be separated from each other by the distance between terminals d of 150 μm with the pitch P of 350 μm.

### Example 3

A touch panel was manufactured by the same method as that in Example 1, except for arranging the first external connection terminals to be separated from each other by the distance between terminals d of 200 μm with the pitch P of 400 μm.

### Example 4

A touch panel was manufactured by the same method as that in Example 1, except for arranging the first external connection terminals to be separated from each other by the distance between terminals d of 150 μm and respectively setting the terminal width W as 150 μm.

### Example 5

A touch panel was manufactured by the same method as that in Example 4, except for arranging the first external connection terminals with the pitch P of 400 μm and respectively setting the terminal width W as 250 μm.

### Example 6

A touch panel was manufactured by the same method as that in Example 1, except for arranging the first external connection terminals to be separated from each other by the distance between terminals d of 200 μm with the pitch P of 500 μm and respectively setting the terminal width W as 300 μm.

### Example 7

The first detection electrodes, first peripheral wirings, and first external connection terminals were formed on the front surface of the resin substrate the pattern formation method described above, second detection electrodes, second peripheral wirings, and second external connection terminals configured with Ag films having a film thickness of 1 μm were formed on the rear surface of the resin substrate the pattern formation method described above, and accordingly, a conductive film for a touch panel shown in FIG. 1 was manufactured. Here, the first external connection terminals and the second external connection terminals formed on the front surface and the rear surface of the resin substrate were arranged to be separated from each other by the distance between terminals d of 150 μm with the pitch P of 350 m, and the terminal width W thereof was respectively 200 μm. The first external connection terminal and the second external connection terminal are disposed to be separated from each other by the distance between terminals D of 100 μm along the plane direction of the resin substrate. The first detection electrodes and the second detection electrodes formed to have a mesh shape (cell pitch: 300 μm) having a line width of 3 μm and an opening ratio of 98 and formed of typical cells of a rhomboid having an angle of an acute angle of 60°, the first peripheral wirings and the second peripheral wirings were formed with a line width of 20 μm and the minimum gap of 20 μm, and the first external connection terminals and the second external connection terminals were formed with the length L of 1 mm. Here, the mesh pattern of the first detection electrode and the mesh pattern of the second detection electrode are dispose as shown in FIG. 2 and a mesh shape (cell pitch: 150 μm) having an opening ratio of 96% was formed by combining the mesh pattern of the first detection electrodes and the mesh pattern of the second detection electrodes with each other.

When the thermal treatment at 130° C. for 30 minutes was performed with respect to the conductive film for a touch panel manufactured, a coefficient of thermal shrinkage was 0.16%.

Then, the thermocompression bonding of two flexible circuit substrates obtained by forming electrodes formed of copper having a thickness of 12 μm on a surface of a substrate formed of polyimide having a thickness of 25 μm was performed with respect to the front surface and the rear surface of the conductive film for a touch panel at 130° C. for 20 seconds, with an anisotropic conductive film having a particle diameter of conductive particles of 10 μmφ (CP920AM-16AC: Dexerials Corporation) interposed therebetween, and a touch panel was manufactured.

### Example 8

A touch panel was manufactured by the same method as that in Example 7, except for disposing the first external connection terminal and the second external connection terminal to be separated from each other by the distance between terminals D of 300 μm along the plane direction of the resin substrate.

### Example 9

A touch panel was manufactured by the same method as that in Example 7, except for disposing the first external connection terminal and the second external connection terminal to be separated from each other by the distance between terminals D of 500 m along the plane direction of the resin substrate.

### Example 10

A touch panel was manufactured by the same method as that in Example 1, except for fanning a first insulating protective layer on the rear surface of the resin substrate of the conductive film for a touch panel so as to correspond to the first detection electrodes. Here, the first insulating protective layer is configured with an adhesive portion formed of an optical clear adhesive (OCA) having a thickness of 25 μm (OCA #8146-1 manufactured by 3M was used), and a protective portion formed of polyethylene terephthalate having a thickness of 25 μm.

### Example 11

A touch panel was manufactured by the same method as that in Example 2, except for forming a first insulating protective layer on the rear surface of the resin substrate of the conductive film for a touch panel so as to correspond to the first detection electrodes. Here, the first insulating protective layer is configured with an adhesive portion twined of an optical clear adhesive (OCA) having a thickness of 25 μm (OCA #8146-1 manufactured by 3M was used), and a protective portion formed of polyethylene terephthalate having a thickness of 25 μm.

### Example 12

A touch panel was manufactured by the same method as that in Example 8, except for forming a first insulating protective layer on the rear surface of the resin substrate of the conductive film for a touch panel so as so as to correspond to the first detection electrodes, and forming a second insulating protective layer on the front surface of the resin substrate so as to correspond to the second detection electrodes. Here, the first insulating protective layer is configured with an adhesive portion formed of an optical clear adhesive (OCA) having a thickness of 25 μm (OCA #8146-1 manufactured by 3M was used), and a protective portion formed of polyethylene terephthalate having a thickness of 25 μm. In addition, the second insulating protective layer is configured with an adhesive portion formed of an optical clear adhesive (OCA) having a thickness of 50 μm (OCA #8146-2 manufactured by 3M was used), and a protective portion formed of polyethylene terephthalate having a thickness of 25 μm.

### Example 13

A touch sensor film was manufactured by the same method as that in Example 1, except for manufacturing a resin substrate by pertaining surface hydrophilizing by corona discharge treatment with respect to a surface of a sheet famed of a cycloolefine polymer (COP) having a thickness of 40 μm which is subjected to thermal treatment at 130° C. for 3 minutes while applying tension of 15 N. When the thermal treatment at 130° C. for 30 minutes was performed with respect to the conductive film for a touch panel, a coefficient of thermal shrinkage was 0.16%.

### Example 14

A touch sensor film was manufactured by the same method as that in Example 8, except for manufacturing a resin substrate by performing surface hydrophilizing by corona discharge treatment with respect to a surface of a sheet formed of a cycloolefine polymer (COP) having a thickness of 40 m which is subjected to thermal treatment at 130° C. for 3 minutes while applying tension of 15 N. When the thermal treatment at 130° C. for 30 minutes was performed with respect to the conductive film for a touch panel, a coefficient of thermal shrinkage was 0.16%.

### Example 15

A touch sensor film was manufactured by the same method as that in Example 12, except for manufacturing a resin substrate by performing surface hydrophilizing by corona discharge treatment with respect to a surface of a sheet (a coefficient of thermal shrinkage due to thermal treatment at 130° C. for 30 minutes was 0.16%) formed of a cycloolefine polymer (COP) having a thickness of 40 m which is subjected to thermal treatment at 130° C. for 3 minutes while applying tension of 15 N, and using a cycloolefine polymer (COP) having a thickness of 40 μm for the protective portion of the first insulating protective layer and the protective portion of the second insulating protective layer.

### Comparative Example 1

A touch sensor film was manufactured by the same method as that in Example 1, except for arranging the first external connection terminals to be separated from each other by the distance between terminals d of 50 μm with the pitch P of 250 μm.

### Comparative Example 2

A touch sensor film was manufactured by the same method as that in Example 1, except for arranging the first external connection terminals to be separated from each other by the distance between terminals d of 250 μm with the pitch P of 450 μm.

### Comparative Example 3

A touch sensor film was manufactured by the same method as that in Example 4, except for arranging the first external connection terminals with the pitch P of 250 μm and respectively setting the terminal width W as 100 μm.

### Comparative Example 4

A touch sensor film was manufactured by the same method as that in Example 6, except for arranging the first external connection terminals with the pitch P of 550 μm and respectively setting the terminal width W as 350 μm.

<Evaluation Method>

(Deformation of Resin Substrate)

When the resin substrate was visually observed, a case where no deformation of the resin substrate is recognized was evaluated as A, a case where slight deformation of the resin substrate is recognized was evaluated as B, a case where deformation of the resin substrate is recognized but it is deformation to the extent that electric connection between the conductive film for a touch panel and the flexible circuit substrate is maintained was evaluated as C, and a case where deformation occurs to the extent that electric connection between the conductive film for a touch panel and the flexible circuit substrate cannot be maintained was evaluated as D.

The results are shown in a first table to a fourth table below.

(Alignment of External Connection Terminals)

When the first external connection terminals or both of the first external connection terminals and the second external connection terminals were visually observed, a case where substantially no deviation in alignment thereof with respect to the flexible circuit substrate occurs was evaluated as A, and a case where deviation in alignment thereof with respect to the flexible circuit substrate occurs was evaluated as B.

The results are shown in the first table to the fourth table below.

(Contact Properties of External Connection Terminals and Flexible Circuit Substrate)

The inspection regarding electric connection between the first external connection terminals or the second external connection terminals connected to the flexible circuit substrate, and the flexible circuit substrate was performed by measuring resistance using a probe. A case where excellent electric contact with respect to the flexible circuit substrate is held and a resistance value is equal to or smaller than 40 Ω was evaluated as A, a case where electric contact with respect to the flexible circuit substrate is held and a resistance value is greater than 40 Ω and equal to or smaller than 60 Ω was evaluated as B, and a case where electric contact with respect to the flexible circuit substrate is not held due to a resistance value greater than 60 Ω, and electric connection is not realized was evaluated as C.

The results are shown in the first table to the fourth table below.

TABLE 1
First Table

| | Resin | External connection terminals | | | | External connection | |
|---|---|---|---|---|---|---|---|
| | substrate | Distance | | | | terminals | |
| | Thickness | between | Terminal | Pitch P | Resin substrate | | Contact |
| | (μm) | terminals d (μm) | width W (μm) | (μm) | Deformation | Alignment | properties |
| Example 1 | 38 | 100 | 200 | 300 | B | A | A |
| Example 2 | 38 | 150 | 200 | 350 | B | A | A |
| Example 3 | 38 | 200 | 200 | 400 | B | A | B |
| Comparative | 38 | 50 | 200 | 250 | B | A | Short circuit |
| Example 1 | | | | | | | |
| Comparative | 38 | 250 | 200 | 450 | D | A | C |
| Example 2 | | | | | | | |
| Example 4 | 38 | 150 | 150 | 300 | B | A | B |
| Example 5 | 38 | 150 | 250 | 400 | B | A | A |
| Comparative | 38 | 150 | 100 | 250 | D | A | C |
| Example 3 | | | | | | | |
| Example 6 | 38 | 200 | 300 | 500 | B | A | A |
| Comparative | 38 | 200 | 350 | 550 | B | B | C |
| Example 4 | | | | | | | |

It was found from the results shown in the first table that, in Examples 1 to 3 in which the first external connection terminals are arranged to be separated from each other by the distance between terminals d of 100 μm to 200 μm with the pitch P equal to or smaller than 500 μm, and the terminal width W equal to or greater than the distance between terminals d is respectively set, contact properties of the first external connection terminals are significantly improved, compared to Comparative Example 1 in which the distance between terminals d of the first external connection terminals is less than 100 μm. Here, the first external connection terminals of Comparative Example 1 adjacent to each other had short-circuited.

It was found that, in Examples 1 to 3, the deformation of the resin substrate is significantly prevented and the contact properties of the first external connection terminals are significantly improved, compared to Comparative Example 2 in which the distance between terminals d of the first external connection terminals is greater than 200 μm.

It was found that, in Examples 4 and 5 in which the first external connection terminals are arranged to be separated from each other by the distance between terminals d of 100 μm to 200 μm with the pitch P equal to or smaller than 500 μm, and the terminal width W equal to or greater than the distance between terminals d is respectively set, the deformation of the resin substrate is significantly prevented and the contact properties of the first external connection terminals are significantly improved, compared to Comparative Example 3 in which the terminal width W of the first external connection terminals is smaller than the distance between terminals d.

It was found that, in Example 6 in which the first external connection terminals are arranged to be separated from each other by the distance between terminals d of 100 μm to 200 μm with the pitch P equal to or smaller than 500 μm, and the terminal width W equal to or greater than the distance between terminals d is respectively set, the alignment and the contact properties of the first external connection terminals are significantly improved, compared to Comparative Example 4 in which the pitch P of the first external connection terminals is greater than 500 μm.

It was found that, in Examples 1, 2, 5, and 6 in which the terminal width W of the external connection terminals is equal to or greater than a minimum width obtained by adding 50 μm to the distance between terminals d and equal to or smaller than a maximum width obtained by adding 100 μm to the distance between terminals d, the contact properties are particularly excellent, compared to Comparative Examples 3 and 4 in which the terminal width W of the external connection terminals is smaller than a minimum width obtained by adding 50 μm to the distance between terminals d.

TABLE 2
Second Table

| | | | | | First external | | | |
|---|---|---|---|---|---|---|---|---|
| | | | | | connection | | | |
| | | | | | terminals and | | | |
| | | | | | second external | | | |
| | | External connection terminals | | | connection | | | |
| | Resin | Distance | | | terminals | | External connection | |
| | substrate | between | Terminal | | Distance | | terminals | |
| | Thickness | terminals | width W | Pitch P | between | Resin substrate | | Contact |
| | (μm) | d (μm) | (μm) | (μm) | terminals D | Deformation | Alignment | properties |
| Example 7 | 38 | 150 | 200 | 350 | 100 | C | A | A |
| Example 8 | 38 | 150 | 200 | 350 | 300 | B | A | A |
| Example 9 | 38 | 150 | 200 | 350 | 500 | B | A | A |

It was found from the results shown in the second table that, in Examples 8 and 9 in which the first external connection terminal and the second external connection terminal are disposed to be separated from each other by the distance between terminals D equal to or greater than 300 μm along the plane direction of the resin substrate in the orthogonal plane orthogonal to the resin substrate, the deformation of the resin substrate is prevented, compared to Comparative Example 7 in which the distance between terminals D is smaller than 300 μm.

TABLE 3
Third Table

| | | | | | First external | | | | |
|---|---|---|---|---|---|---|---|---|---|
| | | | | | connection | | | | |
| | | | | | terminals and | | | | |
| | | | | | second | | | | |
| | | | | | external | | | | |
| | | External connection terminals | | | connection | | | | |
| | Resin | Distance | | | terminals | | | External connection | |
| | substrate | between | Terminal | | Distance | Insulating | | terminals | |
| | Thickness | terminals | width W | Pitch | between | protective | Resin substrate | | Contact |
| | (μm) | d (μm) | (μm) | P (μm) | terminals D | layer | Deformation | Alignment | properties |
| Example | 38 | 100 | 200 | 300 | — | Formed | A | A | A |
| 10 | | | | | | | | | |
| Example | 38 | 150 | 200 | 350 | — | Formed | A | A | A |
| 11 | | | | | | | | | |
| Example | 38 | 150 | 200 | 350 | 300 | Formed | A | A | A |
| 12 | | | | | | | | | |

It was found from the results shown in the third table that, in Examples 10 to 12 in which an insulating protective layer having a thickness of 20 μm to 150 μm is formed on a surface on a side opposite to the surface where the external connection terminals are formed, so as to correspond to a terminal formation area where the external connection terminals are formed, the deformation of the resin substrate is more significantly prevented, compared to Examples 1 and 2 and Comparative Example 8 in which the insulating protective layer is not formed.

TABLE 4
Fourth Table

| | | | | | First external | | | | |
|---|---|---|---|---|---|---|---|---|---|
| | | | | | connection | | | | |
| | | | | | terminals and | | | | |
| | | | | | second | | | | |
| | | | | | external | | | | |
| | | External connection terminals | | | connection | | | | |
| | Resin | Distance | | | terminals | | | External connection | |
| | substrate | between | Terminal | | Distance | Insulating | | terminals | |
| | Thickness | terminals | width W | Pitch | between | protective | Resin substrate | | Contact |
| | (μm) | d (μm) | (μm) | P (μm) | terminals D | layer | Deformation | Alignment | properties |
| Example | 40 | 100 | 200 | 300 | — | Not formed | B | A | A |
| 13 | | | | | | | | | |
| Example | 40 | 150 | 200 | 350 | 300 | Not formed | B | A | A |
| 14 | | | | | | | | | |
| Example | 40 | 150 | 200 | 350 | 300 | Formed | A | A | A |
| 15 | | | | | | | | | |

It was found from the results shown in the fourth table that, Examples 13 to 15 in which a sheet formed of a cycloolefine polymer (COP) having a thickness of 40 μm which is subjected to thermal treatment at 130° C. for 3 minutes while applying tension of 15 N was used as the resin substrate, excellent results of the deformation of the resin substrate, the alignment of the external connection terminals, and the contact properties of the external connection terminals are obtained, in the same manner as in Examples 1, 8, and 12 in which a sheet formed of polyethylene terephthalate (PET) having a thickness of 38 μm which is subjected to thermal treatment at 150° C. for 3 minutes while applying tension of 20 N was used as the resin substrate.

### EXPLANATION OF REFERENCES

1: resin substrate

2: first detection electrode

3: second detection electrode

4: first peripheral wiring

5: first external connection terminal

6: second peripheral wiring

7: second external connection terminal

8: first connector portion

9: second connector portion

10a, 10b:

11: one edge

21: first insulating protective layer

22: second insulating protective layer

23: protective portion

24: adhesive portion

31: conductive film for a touch panel

32: flexible circuit substrate

32a: first flexible circuit substrate

32b: second flexible circuit substrate

33: anisotropic conductive film

34a: first flexible substrate

34b: second flexible substrate

35a: first electrode

35b: second electrode

36: cover member

37: adhesive portion

D1: first direction

D2: second direction

d: distance between terminals

P: pitch

W: terminal width

L: length of external connection terminal

C: cell

R1, R2: terminal formation area

What is claimed is:

1. A conductive film for a touch panel comprising:
a flexible transparent resin substrate having a thickness equal to or smaller than 40 μm;
a plurality of detection electrodes which are formed on at least one surface of the resin substrate;
a plurality of peripheral wirings which are formed on at least one surface of the resin substrate and respectively connected to the plurality of detection electrodes; and
a plurality of external connection terminals which are formed on at least one surface of the resin substrate and respectively connected to the plurality of peripheral wirings,
wherein the plurality of external connection terminals are arranged such that adjacent external connection terminals are separated from each other by a distance between terminals of 100 μm to 200 μm with a pitch equal to or smaller than 500 μm, and respectively have a terminal width equal to or greater than the distance between terminals.

2. The conductive film for a touch panel according to claim 1,
wherein the terminal width of each of the plurality of external connection terminals is equal to or greater than a minimum width obtained by adding 50 μm to the distance between terminals and equal to or smaller than a maximum width obtained by adding 100 μm to the distance between terminals.

3. The conductive film for a touch panel according to claim 1,
wherein a coefficient of thermal shrinkage of the conductive film for a touch panel due to thermal treatment at 130° C. for 30 minutes is equal to or smaller than 0.20%.

4. The conductive film for a touch panel according to claim 1, further comprising:
an insulating protective layer having a thickness of 20 μm to 150 μm which is formed on a surface of the resin substrate on a side opposite to the surface where the plurality of external connection terminals are formed, so as to correspond to a terminal formation area where the plurality of external connection terminals are formed.

5. The conductive film for a touch panel according to claim 1,
wherein the resin substrate is formed of polyethylene terephthalate or a cycloolefine polymer.

6. The conductive film for a touch panel according to claim 1,
wherein the plurality of detection electrodes have a mesh shape having an opening ratio equal to or greater than 90%.

7. The conductive film for a touch panel according to claim 1,
wherein the plurality of detection electrodes, the plurality of peripheral wirings, and the plurality of external connection terminals are respectively formed on both surfaces of the resin substrate.

8. The conductive film for a touch panel according to claim 7,
wherein the external connection terminals which are present at the closest positions between the plurality of external connection terminals formed on one surface of the resin substrate and the plurality of external connection terminals fanned on the other surface are disposed to be separated from each other by a distance equal to or greater than 300 μm in a direction along a plane direction of the resin substrate.

9. The conductive film for a touch panel according to claim 2,
wherein a coefficient of thermal shrinkage of the conductive film for a touch panel due to thermal treatment at 130° C. for 30 minutes is equal to or smaller than 0.20%.

10. The conductive film for a touch panel according to claim 2, further comprising:
an insulating protective layer having a thickness of 20 μm to 150 μm which is formed on a surface of the resin substrate on a side opposite to the surface where the plurality of external connection terminals are formed, so as to correspond to a terminal formation area where the plurality of external connection terminals are formed.

11. The conductive film for a touch panel according to claim 2,
wherein the resin substrate is formed of polyethylene terephthalate or a cycloolefine polymer.

12. The conductive film for a touch panel according to claim 2,
wherein the plurality of detection electrodes have a mesh shape having an opening ratio equal to or greater than 90%.

13. The conductive film for a touch panel according to claim 2,
wherein the plurality of detection electrodes, the plurality of peripheral wirings, and the plurality of external connection terminals are respectively formed on both surfaces of the resin substrate.

14. The conductive film for a touch panel according to claim 13,
wherein the external connection terminals which are present at the closest positions between the plurality of external connection terminals formed on one surface of the resin substrate and the plurality of external connection terminals formed on the other surface are disposed to be separated from each other by a distance equal to or greater than 300 μm in a direction along a plane direction of the resin substrate.

15. The conductive film for a touch panel according to claim 9, further comprising:
an insulating protective layer having a thickness of 20 μm to 150 μm which is formed on a surface of the resin substrate on a side opposite to the surface where the plurality of external connection terminals are formed, so as to correspond to a terminal formation area where the plurality of external connection terminals are formed.

16. The conductive film for a touch panel according to claim 15,
wherein the resin substrate is formed of polyethylene terephthalate or a cycloolefine polymer.

17. The conductive film for a touch panel according to claim 16,
wherein the plurality of detection electrodes have a mesh shape having an opening ratio equal to or greater than 90%.

18. The conductive film for a touch panel according to claim 17,
wherein the plurality of detection electrodes, the plurality of peripheral wirings, and the plurality of external connection terminals are respectively formed on both surfaces of the resin substrate.

19. The conductive film for a touch panel according to claim 18,
wherein the external connection terminals which are present at the closest positions between the plurality of external connection terminals formed on one surface of the resin substrate and the plurality of external connection terminals formed on the other surface are disposed to be separated from each other by a distance equal to or greater than 300 μm in a direction along a plane direction of the resin substrate.

20. A touch panel comprising:
the conductive film for a touch panel according to claim 1;
a flexible circuit substrate on which a plurality of electrodes are formed; and
an anisotropic conductive film which is disposed between the conductive film for a touch panel and the flexible circuit substrate, and connects the plurality of external connection terminals of the conductive film for a touch panel and the plurality of electrodes of the flexible circuit substrate to each other.
